(19) United States
(12) Patent Application Publication
(10) Pub. No.: US 2016/0348426 A1
(43) Pub. Date: Dec. 1, 2016

(54) BLINDS SYSTEM FOR INSTALLATION NEXT TO A WINDOW OR DOOR PANE OR WHICH CAN GENERALLY BE USED AS PARTITION

(71) Applicant: Boran GLAVAS, Zagreb (HR)

(72) Inventor: Boran GLAVAS, Zagreb (HR)

(21) Appl. No.: 15/114,654

(22) PCT Filed: Jan. 28, 2014
(86) PCT No.: PCT/HR2014/000005

§ 371 Date: Jul. 27, 2016

(51) Int. Cl. E06B 9/32; E06B 9/327; E06B 9/262

(52) U.S. Cl. CPC E06B 9/32; E06B 9/262; E06B 9/327; E06B 2009/2625; E06B 2009/2627; E06B 2009/3222

(57) ABSTRACT

Blinds system (1) for installation next to a window or door pane (10) or which can generally be used as partition, the blinds system (1) consisting of a blinds (12) whose two ends are fixed to the pair of battens (4), a pair mutually opposed longitudinal and parallel guides (2), mutually operating blinds battens (4;5) by the means of magnets (8;8a) for shifting blinds (12), where at the end of the battens (4;5) are arranged end parts (3;3a) each containing at least one magnet (8;8a) where magnets (8; 8a) are arranged to be in the opposite magnet pole in order to mutually attract each other, where longitudinal guides (2) are arranged to receive end parts (3) of the battens (4). Longitudinal guides (2) for guiding blinds battens (4) and for holding the blinds (12) in one plane preventing their deflection have U shaped hollow square or rectangular cross-section outline. Longitudinal guides (2) comprise two mutually oppositely arranged longitudinally extending ribs (13). According to the preferred embodiment of the invention, longitudinal guides (2) comprise two mutually oppositely arranged ribs (13) within the inner hollow part of the longitudinal guide (2) forming T-section longitudinal groove for accommodating metal strip (7) along the length of the guide (2). Metal strip (7) attracts at least one magnet (8) arranged in end parts (3) of the pair of battens (4). Vertically or respectively horizontally shifting of the blinds (12) is provided by applying pressure on the batten (4) in order to distance said batten from the metal strip (7) and easily shift batten (4) and thus blind (12) in a desired position.

### DESCRIPTION OF THE INVENTION

Technical Field

Present invention refers to a blinds system for installation next to a window or door pane, or which can be used as partition for the cabinets, wardrobes, racks and shelf units. Beside its use in the racks and shelf units as a partition or as a door for the said furniture, present invention can be easily used as a partition for separating any space in the home apartment. Specifically, the invention relates to a blinds system that may be arranged in structure such as window or door, cabinets, wardrobes, racks and shelf units without interfering with the structure. Further, present invention refers to the blinds system regulated by magnets, particularly to the guiding means adapted to operate with the magnets.

Technical Problem

Conventionally blinds that are arranged next to window or door pane are controlled by cords running through channels. This implies inter alia that the windows need to be specially adapted to comply with the conventional blinds system and that a window that is not specially adapted may not be provided with conventional blinds systems. Problems that appear in the use of classic blinds are: relatively complicated mechanism for their regulation complicated cleaning, impossibility to take the entire blinds down, and an unnecessary complex assembly for the end user.

Problems that appear in the use of freely hanging classic Venetian blinds or pleated blinds using cords by any means to lift and lower the shade to a desired position and fix it in that certain position are:
relatively complicated mechanisms for their regulation with many moving parts,
a total block out option is missing due to cord holes in blades or the pleated material,
in some applications external sash cords getting dirty and worn out,
wind influences negative on the blinds while keeping a window or door open,
cleaning of both windows and blinds,
complex and costly operation to change blades,
from a child safety perspective hanging cords imply danger to young children,
from an esthetic perspective cords and wires are hanging alongside the window, and
the mandatory use of cords limits the scope of use.

Mentioned technical problems are solved, using less number of components in comparison with known blinds systems. By implementing specially designed guides comprising two mutually oppositely arranged longitudinally extending ribs arranged to accommodate metal strip along the length of the guide or to receive end parts of the battens thus ensuring movement of the battens only along the longitudinal guides, and enabling by the means of magnets and/or metal strip shifting and maintaining the blinds or partition in desired vertical or respectively horizontal position. System according to the present invention can be incorporated next to a window or door pane, or as a partition for the cabinets, wardrobes, racks and shelf units, having square or rectangular fixed framework on which system can be incorporated without interfering with the structure of the above mentioned elements. For implementation of the blinds system according to the present invention intended for the separation of room space, it is necessary to set up simple supports for fixing guide system according to the present invention.

### State of the Art

There were many attempts to solve some of the above-mentioned problems, but none of them succeeded to solve all mentioned problems in a simple and financially acceptable way. Known solutions for the regulation of blinds through magnets do not solve the lifting of a larger surface of blinds.

Document US2010/0065227 (NO STRINGS ATTACHED LLC; US) discloses window blind apparatuses, more particularly to a magnetic cordless blind apparatus of a type that may typically be used for residential and commercial window coverings. Document US2010/0065227 provides combinations of one or more adjustable magnetically active tracks, a window covering element, a rod or rods, magnets, optionally a handle or handles, and optionally a blind holder piece to keep the lower portion of the blind in place. Document EP2320021 (EBERHARD WOIKE & SCHOLTYSSEK GREGOR; DE) comprises a pleating (1), which is adjustably arranged at the window frame. The pleating is determined in both end areas by borders as head and base boards (2,3), which are arranged at lateral frame portions of the window frame behind a covering strip (4). The head and base board comprises a retaining element (5) for clamping between the frame portions of the window frame. Holding forces are accomplished by the use of retaining elements (5) which are pressed by springs (6) to the outside and thus afford the corresponding holding forces against the frame members of the window.

Difference between present invention and inventions disclosed in documents US2010/0065227 and EP2320021 lies in the design of the tracks/guides and the associated end parts. Tracks in both state of the art documents serve for holding blind apparatuses in desired position, while according to the present invention guides with integrated ribs serve also for holding the blinds in one plane preventing their deflection and for accommodating end parts of the battens thus preventing falling out from the guide structure and to provide only movement of the battens along the guide. According to the present invention since the end parts tightly fit into the hollow profile of the battens, reliability of the system is provided. Further, way of operating/shifting of the blinds according to present invention differs from related art.

### DETAILED DESCLOSURE OF THE INVENTION

An object of the invention is to improve the adjustability and the usability of the blinds by at the same time reducing number of components of the blinds system, and by simplifying their design thereby simplified production and final assembly is provided.

According to the one embodiment of the invention blinds system for installation next to a window or door pane or which can generally be used as partition, a pair of mutually opposed longitudinal and parallel guides have U shaped hollow square or rectangular cross- section outline, where inner hollow part of the longitudinal guides comprise two mutually oppositely arranged longitudinally extending ribs forming T-section longitudinal groove for accommodating metal strip along the length of the guide. In this embodiment metal strip attracts at least one magnet arranged in end parts of the pair of battens. Vertically or respectively horizontally shifting of the blinds is provided by applying pressure on the batten in order to distance batten from the metal strip and to shift batten and thus blind in a desired position. Since only pair of magnets operating with the metal strip is provided, this embodiment is used for blinds having less weight.

According to the another embodiment of the invention the longitudinal guides comprise two mutually oppositely arranged longitudinally extending ribs where one rib is arranged along the outer side of the longitudinal guides and the other rib is oppositely arranged along one inner side of the longitudinal guide. In this embodiment blinds system comprises a pair of battens mutually operating by the means of at least one magnet arranged at end parts of each batten. Vertically or respectively horizontally shifting of the blinds is provided by mutually operating two pairs of battens. Due to the weight, this embodiment is suitable for blinds applied on the larger surfaces of window or door panes or of partitions.

In both embodiments two mutually oppositely arranged longitudinally extending ribs, in a manner as to lie in same plane, provide movement of the battens only along the longitudinal guides enabling by the means of magnets and/or metal strip shifting and maintaining the blind in desired vertical or respectively horizontal position. Further, implementing the ribs according to the present invention provides simplified final assembly, easy and reliable handling with the blinds.

The present disclosure relates to blinds system for installation next to a window or door pane or which can generally be used as partition. Namely, the developments hereof concern combinations of one or more guides, a window or partition covering element, a rod or rods, magnets, optionally a handle or handles. The present developments may provide privacy and shade from sunlight, or partition of the room space, or implementing blinds system as partition or door for the cabinets, wardrobes, racks and shelf units while allowing enhanced functionality due to a cordless feature. A subject blind can be positioned at the top of the window or door pane to block sunlight and still allow the user to see outside through the lower portion of the window. It can be positioned at or about the lower half of the window to allow the user to block out the ability of people who are walking by, standing outside or across the street from seeing in while allowing the user to see out through the window over the top of the blind. It can even be positioned in or about the middle of the user's window if the user so chooses. The present developments may provide adjustability, in that the blinds can be placed in virtually any portion of the window, and can be used as partition or door element in furniture, or as partition to separate room space fully extended to provide its function as shade or partition. To change the blind position the user may move them down from the top of the element or up from the bottom. The movement is guided by guides operating with magnets arranged in the battens. The covering element may be mounted on the batten or battens and the battens may be inserted into guides and pulled up and down by the user.

### BRIEF DESCRIPTION OF THE DRAWINGS

Hereafter follows a detailed description of the invention with reference to figures, where:

FIG. 1 shows front view of the blinds system according to one embodiment of the invention;

FIG. 2 shows sectional view of the blinds system according to one embodiment of the invention;

FIG. 3 shows front view of the blinds system according to another embodiment of the invention;

FIG. 4 shows sectional view of the blinds system according to another embodiment of the invention;

FIG. 5 shows body plan of the end element;

FIG. 6 shows perspective view of the assembled batten with blinds; and,

FIG. 7 shows batten with extension for fixation of blinds.

### DETAILED DESCRIPTION OF THE INVENTION

In many implementations, the blind apparatus has first and second guide elements (pair of guides) that are adapted to be mounted in parallel alongside a window or similar architectural feature. The guide elements are adapted to receive one or more battens. The guide elements have a ‘U’ shape defining a channel running longitudinally along the respective guide. The magnets are mounted on the end of battens arranged in end parts of the batten. The blinds system include one or more battens, which are disposed to be mounted, with the aid of magnets, such that the respective ends thereof are within the guide channels and the battens themselves are thus in a generally perpendicular orientation to the guide or guides. The blind apparatus may typically also include a window covering element or partition element of a suitable material such as cloth, paper, or a synthetic, adapted to be coupled with the batten or battens. Blinds used in present blinds system (1) can be pleated blinds, wooden blinds, plastic blinds, paper blinds or honey comb blinds.

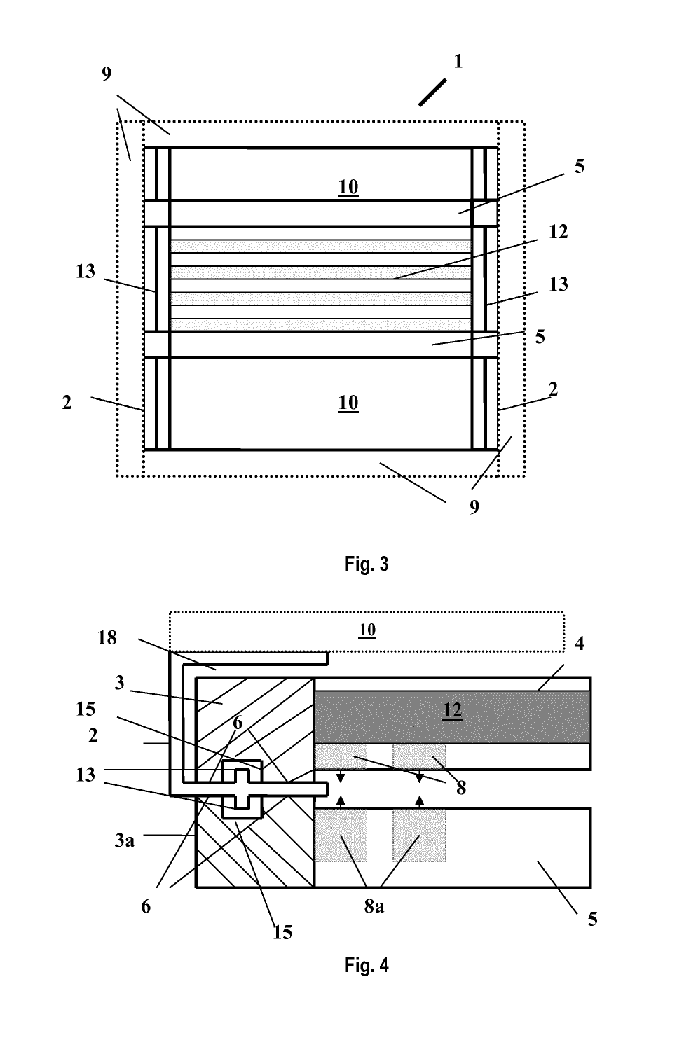

As generally shown in FIGS. 1 and 3 blinds system (1) for installation next to a window or door pane (10) or which can generally be used as partition, the blinds system (1) consisting of a blind (12) whose two ends are fixed to the pair of battens (4), a pair mutually opposed longitudinal and parallel guides (2), mutually operating blinds battens (4;5) by the means of magnets (8;8a) for shifting blinds (12), where at the end of the battens (4;5) are arranged end parts (3;3a) each containing at least one magnet (8;8a) where magnets (8; 8a) are arranged to be in the opposite magnet pole in order to mutually attract each other. Longitudinal guides (2) are arranged to receive end parts (3) of the battens (4) in a way that gaps between longitudinal guides (2) and end parts (3) are provided to the extent necessary to ensure free movement of end parts horizontally and vertically along longitudinal guides (2). Longitudinal guides (2) for guiding blinds battens (4) and for holding the blinds (12) in one plane preventing their deflection have U shaped hollow square or rectangular cross-section outline. Longitudinal guides (2) comprise two mutually oppositely arranged longitudinally extending ribs (13) in a manner as to lie in same plane.

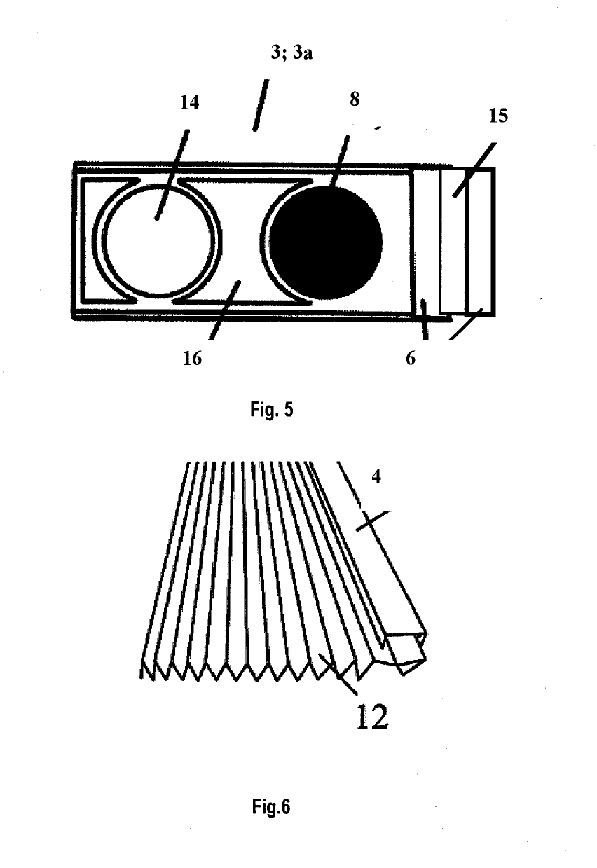

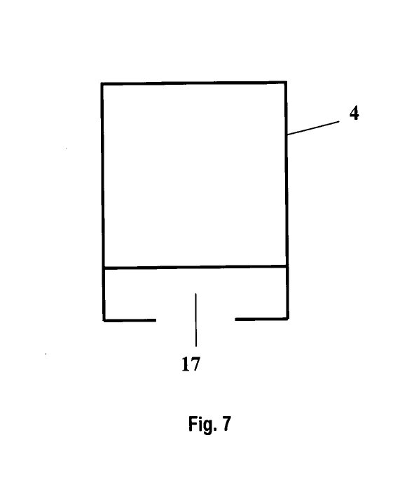

End parts (3;3a) (see FIG. 5) are made in one piece consist of two rectangular parts of different size, where one part is serving for housing at least one magnet (8;8a) and has size to tightly fit into the battens (4;5), while other part extending from the end of the battens (4;5) is serving for sliding along the longitudinal guides (2) has size to fit into the longitudinal guide (2) and to enable shifting of the end part (3) perpendicular to the direction of sliding in order to enable vertically or respectively horizontally shifting of the blind (12). End parts (3; 3a) have cavity (16) which contains at least one socket (14) for placing at least one magnet (8; 8a) where parts (3) are arranged to face metal strips (7) or end parts (3a) of the battens (5) in order that magnets (8) and (8a) and magnets (8) and metal strip (7) mutually attract each other. Further, end parts (3; 3a) have one or two extending ribs (11) forming sliding surfaces (6) where end parts (3; 3a) are positioned in a manner that during shifting of the battens (4; 5) and respectively blinds (12) only the surfaces (6) of the end parts (3; 3a) slide along and are in contact with the longitudinal guides (2). Said magnets should be strong enough to hold the weight of the battens and the blinds, but not too strong so as to produce an obstacle for the user wanting to adapt the position of the battens. The battens (4), see FIGS. 6 and 7, are in the form of the square or rectangular tube with the extensions (17) for fixation of the blinds (12). Battens (5) are in the form of the square or rectangular shaped hollow profile. Battens (4; 5) are formed as square or rectangular shaped hollow profile. Longitudinal guides (2) and battens (4; 5) are formed of aluminium profiles or any other suitable material.

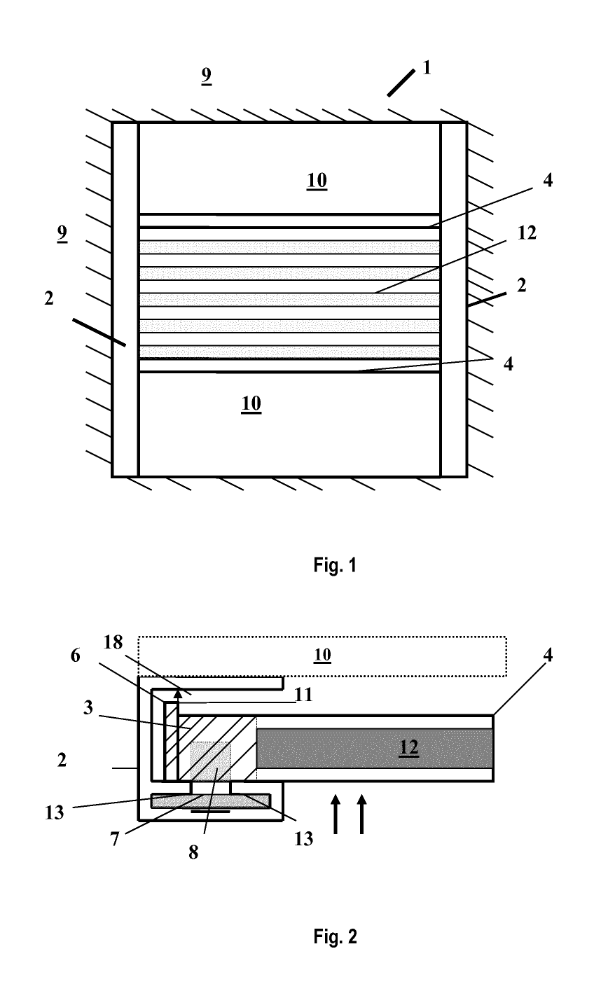

FIG. 2 depicts portions of the blind system (1) according to the one embodiment. A pair of mutually opposed longitudinal and parallel guides (2) has U shaped hollow square or rectangular cross-section outline. Longitudinal guides (2) comprise two mutually oppositely arranged ribs (13) within the inner hollow part of the longitudinal guide (2), in a manner as to lie in same plane, forming T-section longitudinal groove for accommodating metal strip (7) along the length of the guide (2). T-section longitudinal groove is arranged to face magnet (8) arranged in end parts (3). Metal strip (7) and magnet (8) arranged in end parts (3) of the pair of battens (4) mutually attract each other. Shifting of the blind (12) along the longitudinal guide is provided by pressing the batten (4) towards the opposite inner part of the longitudinal guide (2) in order to distance batten (4) from the metal strip (7) thus prevailing action of magnetic field, and easily shift batten (4) and blind (12) in a desired position. End parts (3) have one rib (11), extending oppositely and perpendicular to the inner ribs (13) that form T-section longitudinal groove, forming sliding surfaces (6) where end parts (3) are positioned in a manner that during shifting of the battens (4) and respectively blind (12) only the surfaces (6) of the end parts (3) slide along and are in contact with the opposite inner part of the longitudinal guides (2).

FIG. 4 depicts portions of the blind system (1) according to another embodiment of the invention. A pair of mutually opposed longitudinal and parallel guides (2) has U shaped hollow square or rectangular cross-section outline. Longitudinal guide (2) comprise two mutually oppositely arranged ribs (13) where one rib (13) is arranged along the outer side of the longitudinal guide (2) and the other rib (13) is oppositely arranged along one inner side of the longitudinal guide (2) in a manner as to lie in same plane, where said ribs (13) ensure movement of the battens (4;5) only vertically along the longitudinal guides (2) enabling by the means of magnets (8;8a) shifting and maintaining the blind (12) in desired vertical or respectively horizontal position. Pair of battens (4) and pair of battens (5) are mutually attracted by the means of magnets (8) and respectively magnets (8a) arranged in end parts (3) and respectively end parts (3a). Each of the said end parts contains at least one magnet, but the number of housed magnets depends on the size and the weight of the blinds. Positioning of blind (12) is provided by shifting of battens (5) where battens (4) are also shifted due to the action of corresponding magnets (8; 8a). End parts (3; 3a) on one surface of the part extending from the end of battens (4; 5) have two ribs (11) forming sliding surfaces (6) where end parts (3; 3a) are positioned in a manner that during shifting of the battens (4; 5) and respectively blind (12) only the surfaces (6) of the end parts (3; 3a) slide along and are in contact with the longitudinal guides (2). Further, two extending ribs (11) on end parts (3; 3a) are arranged to form niche (15). Longitudinal guides (2) and end parts (3) are arranged in a manner that rib (13) arranged along hollow inner part of the longitudinal guides (2) is overlapping with the niche (15) of the end parts (3) of the battens (4). Correspondingly, longitudinal guides (2) and end parts (3a) are arranged in a manner that rib (13) arranged along the outer side of the longitudinal guides (2) is overlapping with the niche (15) of the end parts (3a) of the battens (5), see FIG. 4.

Present invention operates with a minimum of components. Installation is intended to be easy and to require minimal tools and time. In preferred embodiment, positioning of the blind along the longitudinal guide is provided by pressing the batten towards the opposite inner part of the longitudinal guide. Accordingly batten and magnet in the said batten is distanced from the metal strip thus prevailing action of magnetic field whereby easy shifting of the batten and blind in a desired position is provided. In both embodiments two mutually oppositely arranged longitudinally extending ribs, in a manner as to lie in same plane, provide movement of the battens only along the longitudinal guides enabling by the means of magnets and/or metal strip shifting and maintaining the blind in desired vertical or respectively horizontal position. Further, implementing the ribs according to the present invention provides simplified final assembly, easy and reliable handling with the blinds.

1. Blinds system (1) for installation next to a window or door pane (10) or which can generally be used as partition, the blinds system (1) comprising a blind (12) whose two ends are fixed to the pair of battens (4), a pair mutually opposed longitudinal and parallel guides (2), mutually operating blinds battens (4;5) by the means of magnets (8;8a),where at the end of the battens (4;5) are arranged end parts (3;3a) each containing at least one magnet (8;8a) where magnets (8; 8a) are arranged to be in the opposite magnet pole in order to mutually attract each other, where longitudinal guides (2) are arranged to receive end parts (3) of the battens (4), characterized in that the longitudinal guides (2) for guiding blinds battens (4) and for holding the blind (12) in one plane preventing blinds deflection have U shaped hollow square or rectangular cross-section outline defining channel, where each longitudinal guide (2) comprises two mutually oppositely arranged longitudinally extending ribs (13) in a manner as to lie in same plane, where two mutually oppositely arranged ribs (13) within the inner hollow part of the longitudinal guide (2) form T-section longitudinal groove for accommodating metal strip (7) along the length of the guide (2) arranged to face magnet (8) in the end part (3), or where one rib (13) is arranged along the outer side of the longitudinal guide (2) and the other rib (13) is oppositely arranged along one inner side of the longitudinal guide (2), where said ribs (13) ensure movement of the battens (4;5) only along the longitudinal guide (2) enabling by the means of magnets (8) and (8a) or magnet (8) and metal strip (7) shifting and maintaining the blind (12) in desired position.

2. Blinds system (1) according to claim 1, characterized by that the end parts (3;3a) are made in one piece consist of two rectangular parts of different size, where one part is serving for housing at least one magnet (8;8a) and has size to tightly fit into the battens (4;5), while other part extending from the end of battens (4;5) is serving for sliding along the longitudinal guides (2) has size to fit into the longitudinal guide (2) in a way that gaps between longitudinal guides (2) and end parts (3) are provided to the extent necessary to ensure free movement of end parts horizontally and vertically along longitudinal guides (2).

3. Blinds system (1) according to claim 1, characterized by that end parts (3; 3a) on one surface of the part extending from the end of battens (4;5) have one or two extending ribs (11) forming sliding surfaces (6) where end parts (3; 3a) are positioned in a manner that during shifting of the battens (4; 5) and respectively blind (12) only the surfaces (6) of the end parts (3; 3a) slide along and are in contact with the longitudinal guides (2).

4. Blinds system (1) according to claim 1, characterized by that one rib (11) on end parts (3) is extending oppositely and perpendicular to the inner ribs (13) that form T-section longitudinal groove where by pressing the batten (4) towards the opposite inner part of the longitudinal guide (2) only the surfaces (6) of the end parts (3) slide along and are in contact with the opposite inner part of the longitudinal guides (2).

5. Blinds system (1) according to claim 3, characterized by that two extending ribs (11) on end parts (3; 3a) are forming sliding surfaces (6) and niche (15).

6. Blinds system (1) according to claim 5, characterized by that longitudinal guides (2) and end parts (3) are arranged in a manner that rib (13) arranged along hollow inner part of the longitudinal guides (2) is overlapping with the niche (15) of the end parts (3) of the battens (4).

7. Blinds system (1) according to claim 5, characterized by that longitudinal guides (2) and end parts (3a) are arranged in a manner that rib (13), arranged along the outer side of the longitudinal guides (2) is overlapping with the niche (15) of the end parts (3a) of the battens (5).

8. Blinds system (1) according to claim 1, characterized by that end parts (3; 3a) have cavity (16) which contains at least one socket (14) for placing at least one magnet (8; 8a) where parts (3) are arranged to face metal strips (7) or end parts (3a) of the battens (5) in order that magnets (8) and (8a) or magnets (8) and metal strip (7) mutually attract each other.

9. Blinds system (1) according to claim 1 any of preceding claims, characterized by that the battens (4; 5) are formed as square or rectangular shaped hollow profile.

10. Blinds system (1) according to claim 1, characterized by that the longitudinal guides (2) and battens (4; 5) are formed of aluminum profiles.
